(19) United States
(12) Patent Application Publication
(10) Pub. No.: US 2011/0206810 A1
(43) Pub. Date: Aug. 25, 2011

(54) Container Based Food Enclosing Items of Value

(76) Inventor: David L. Ross, New York, NY (US)

(21) Appl. No.: 12/709,491

(22) Filed: Feb. 21, 2010

(51) Int. Cl. A21D 13/08

(52) U.S. Cl. 426/87; 426/94; 426/90

(57) ABSTRACT

A food item which contains one or more digestible or non-digestible pharmaceutical items, confirmation tickets, or promotional prizes that provides an efficient and enjoyable means of delivery of items of value. Some examples of container based food items used to distribute items of value include but are not limited to fortune cookies and other food items constructed with hollow cavities inside.

### DETAILED DESCRIPTION OF THE INVENTION:

This invention uses folded dough, folded cookies, fortune cookies, and other container based foods to distribute items of value.

Container based foods may include but are not limited to baking products, sweeteners, folded dough, folded cookies, fortune cookies, puffed wheat, breads, or cereals. Container based foods may also be made of materials such as but not limited to meats, proteins, vegetables, sugars, salts, or other types of food or foods surrounding or enclosing an item of value.

Baking products are materials used in the creation of foods that may be heated by an oven prior to consumption. They include but are not limited to wheat, egg, gluten, flour, yeast, or other common consumable items used in baking.

Sweeteners are digestible items that accentuate the taste of sweet in foods. They can be but are not limited to sugars, saccharin, aspartame, or other combinations of natural or chemical structures that result in a sweet taste.

Folded dough may include baking products that are cooked and manipulated during the cooling process by hand or machine into a shape different than the shape it was cooked or baked.

Folded cookies may include baking products that are cooked and manipulated during the cooling process by hand or machine into a shape different than the shape it was cooked or baked.

Fortune cookies are often crescent-shaped hollow cookies containing a small strip a paper inside imprinted with a short message or “fortune” or written words of wisdom or a vague prophecy. Fortune cookies are often served with Chinese food in Chinese restaurants as a dessert.

A container based food may become a container based food item when an item of value is placed inside the container based food.

The size of a fortune cookie, folded dough, container based food, or container based food item can be measured either before it is cooked or folded or after it is cooked or folded. The measurement size could be determined across length, width, or depth.

Fortune cookies, folded dough, container based foods, or container based food items may be consumed whole or opened prior to consumption. They may be consumed as a single item or opened to remove the item of value inside.

Items of value located inside the container based food may have value independent of the cookie and include but are not limited to digestible or non-digestible pharmaceutical items, confirmation tickets, promotional prizes, condiments, or other foods.

Digestible pharmaceutical items are chemical compounds that are consumed by humans or animals and that pass through the mouth, throat, and digestive system of the human or animal. Some examples are but are not limited to vitamins, pills, drugs, capsules, powders, over the counter medication, prescription medication, supplements, processed chemicals, controlled substances, or other forms and combinations of chemical or natural substances.

Non-digestible pharmaceutical items are chemical compounds that are not intended to be consumed by humans or animals through their mouth, throat, or digestive track but are instead delivered through other means. Some examples are but are not limited to hand or skin creams, eye drops, nose drops, ear medicine, hair medicine, or other forms of medicines or vitamins that are not consumed through the mouth.

Confirmation tickets are physical presentations of information that confirm a piece of information. Some examples are but are not limited to lottery, coupons, novelty game pieces, event tickets, receipts, or other forms of written confirmation.

Promotional prizes are rewards for activity or use of an item. Promotional prizes can be but are not limited to a plurality of toys, tools, keys, or other prizes or promotional items.

Condiments are foods to accentuate the flavor or taste of accompanying food. Some examples of condiments are salt, ketchup, mustard, sauces, oils, candies, or other foods which may be delivered in packaged or unpackaged form.

Non-Paper based items may include all items that are not composed of processed tree pulp. Non-paper based items may include items such as digestible pharmaceuticals, non-digestible pharmaceutical, promotional prizes, condiments, or other items. Non-paper based items may include confirmation tickets where by the confirmation tickets are not comprised of paper-based goods.

A container based food item could contain an individual item or multiple items of value of similar or different construction. For example one item may include a vitamin or medicine and another may include instructions, reminders, or other messages on how to use the vitamin or medicine.

The item or items of value may include single or multiple doses, or single or multiple other items of value inside the container based food item.

One example of the container based food item may include a fortune cookie with vitamins or medicine contained inside. Another example could be puffed wheat that includes a game piece. Another example may include a fortune cookie with a bill, receipt, or other confirmation note printed inside. Another example may include a tube shaped cracker with a puzzle piece or pieces inside that make up a promotional or other competitive game. Another example may include a sugar enclosed structure that contains tea leaves in a dissolvable tea bag.

The container based food item may, in some embodiments, be eaten whole or the container may be pierced or opened allowing the consumer to access the item inside followed by consumption of the food item.

By enclosing an item of value in the hollow cavity between the edges of a container based food item the item of value is able to maintain its original consistency without interacting with the contents of the food item. For example a pharmaceutical pill, as the item of value, may be sensitive to heat or moisture. Cooking or baking a pharmaceutical item into a food product may alter the chemical properties of the pharmaceutical item or decrease its effectiveness. In one embodiment of this invention a pharmaceutical pill may be stored within the hollow cavity of the fortune cookie, not heated within an oven, and solely subjected to the heat radiated off the cookie during its cooling process thereby maintaining its chemical state unaltered.

The container based food may have different branding indicators before or after the item of value is enclosed. Branding indicators are means of communicating a message or concept relative to the origin or ownership of an item to a viewer. They include but are not limited to combinations of differing pictures, symbols, words, colors, shapes, sizes, materials, patterns or a combination branding indicators. One example of this could be that all non-prescription medicines are exclusively denoted with green stripes on the outside of the container based food item. Another example could denote that all container based foods that display the corporate colors, patterns, brands, or logos of a particular pharmaceutical company contain medicines manufactured by that pharmaceutical company. Another example could include colors, shapes, sizes to denote the order of consumption of the container based food item and its respective item or items inside such as day of week, time of day, or other sequence of consumption.

Branding indicators could include messaging inside the container based food, on the container based food, or on any external packaging of the container based food. This messaging could be used to reinforce a message through repetition or other means.

The container based food may be constructed of expiration chemicals, or dyes or other chemicals that change color or pattern or otherwise indicate an expiration date or other invalidation information with respect to the consumption of the container based food item or the items inside. One example of this could be that the container based food changes from green to yellow to red to denote the expiration date of a medicine or vitamin, the validity of a game piece, or other time sensitive information about the container based food or item enclosed. An example of a similar embodiment where expiration chemicals are used is in the toothbrush industry wherein chemicals are applied to tooth bristles wherein the colors of bristles slowly change in color over time.

The container based food may be made of ingredients that work in conjunction or in concert to improve the effectiveness of the item enclosed inside. Ingredients may include but are not limited to fortified proteins, vitamins, oils, or other medicines. One example of this could assist with the separation of two medicines whereby one medicine may be baked into the container based food and the other is contained inside as the chemical structure of each independent medicine may require synthesis inside the human body to be effective. Another example of this may include the ability for new constructions of vitamins or medicines by separating out medicines for resubmission to government or industry regulators.

The container based food may be constructed with locking lips, or internally raised edges inside the container based food, in order to reduce movement of and to increase stability of the item of value while it is inside the hollow cavity of the container based food.

Where the item of value in the container based food item is a lottery or game piece, the container based food item may be used to conceal secret codes or other messages. One example of this could be a lottery game piece that is written on ink or other printable material that is only revealed after interacting with the container based food, its heating or cooling process, or the process of opening or consuming the container based food.

The container based food or the container based food item could be constructed by machine or by hand using common food preparation methods and may be baked, fried, mixed, molded, or constructed in other ways.

The insertion of the item into the container based food could be implemented in several ways. One method could be to include the item of value during the cooking process. Another could be to open the item during the cooling process to insert the item. Another method could include a hole in the top of the container based food, drop in the item of value, and then seal the container based food item. The container based food may have a flap or resealable component on one of its sides for insertion of the item of value. Another example of the insertion of the item of value into the container based food would be to construct the container based food in multiple parts and join them together around the item of value. Where the item of value is a liquid it may be injected into the container based food. Another example of the insertion could be the manual or mechanical folding of the container based food around the item of value as is done with the construction of fortune cookies.

The container based food item may be packaged individually or in groups of edible or non-edible materials and the container based food item may be protected through vacuum packaging or other protective means as to not pierce, crush, or combine the container based food with the item of value. The packaging of or the container based food item may change colors or patterns to denote an expiration date or other invalidation or that the packaging surrounding the container based food item has been opened, tampered with, or compromised in another way. The container based food or container based food item may change colors or patterns to denote an expiration date or other invalidation or that the packaging surrounding the container based food item has been opened, tampered with, or compromised in another way.

Fortune cookies are produced by mixing egg whites, sugar, starches, oils, flavoring extracts, water, and other ingredients in varying consistencies into a batter. The batter is then placed into a rounded fashion where it is then baked at temperatures above 100 degrees Celsius for over 30 seconds. The cooked batter is removed from heat and a small printed sheet of paper is then laid on top of the cooked batter. The cooked batter is folded to encapsulate the printed sheet of paper forming the common fortune cookie shape. Often fortune cookies are then packaged by enveloping them in plastic and then packed individually by cutting and sealing plastic surrounding the fortune cookie. Although fortune cookie batter is often poured in a round shape, fortune cookies could also be made from batter in varying shapes such as oval or quadrilateral. Although they're commonly folded lengthwise then widthwise to form a crescent fortune cookies can be folded in several ways to encapsulate an item or items of value in a non-crescent shape.

Fortune cookies are often consumed by first opening the plastic encasement surrounding the cookie. This is often followed by separating the two opposite sides of the cookie breaking the cookie down the middle. The consumer often removes the printed message encased within the fortune cookie and consumes the cookie.

Dried consumable beverages are powders and other dried substances that when combined with water or other liquids they are consumed. Some examples of dried consumable beverages are but are not limited to tea, iced tea, coffee, instant coffee, powdered milk, hot chocolate, hot cocoa, and other forms of drinks. Dried consumable beverages may be powders or other forms of ground materials. It is common for consumers to add a personal preference of sweetener to these items.

What is claimed is:

1. A fortune cookie greater than 1 centimeter in size that encloses at least one digestible pharmaceutical item in at least one hollow cavity of folded dough.

2. A container based food consisting of folded dough greater than 1 centimeter in size that includes at least one confirmation ticket enclosed in at least one hollow cavity inside the container based food.

3. A container based food that is greater than 1 centimeter in size that comprises at least one non-paper based item of value enclosed in at least one hollow cavity inside the container based food.

4. The item of value of claim 3, wherein said item is at least one digestible pharmaceutical item.

5. The item of value of claim 3, wherein said item is at least one non-digestible pharmaceutical item.

6. The item of value of claim 3, wherein said item is at least one promotional prize.

7. The item of claim 3, wherein the container based food includes at least one branding indicator.

8. The item of claim 3, wherein the container based food includes at least one sweetener and the item inside includes at least one dried consumable beverage.

9. The item of claim 3, wherein container based food includes at least one expiration chemical.

10. The item of claim 3, wherein container based food includes at least one baking product and encloses at least one digestible pharmaceutical item.

11. The item of claim 3, wherein container based food includes at least one baking product and encloses at least one non-digestible pharmaceutical item.

12. The item of claim 3, wherein container based food includes at least one baking product and encloses at least one promotional prize.

13. The item of claim 3, wherein container based food includes at least one expiration chemical and encloses at least one digestible pharmaceutical item.

14. The item of claim 3, wherein container based food includes at least one expiration chemical and encloses at least one non-digestible pharmaceutical item.

15. The item of claim 3, wherein container based food includes at least one expiration chemical and encloses at least one promotional prize.

16. The item of claim 3, wherein the container based food includes at least one locking lip to hinder motion of at least one item inside the hollow cavity of the container based food.
